(19) United States
(12) Patent Application Publication
(10) Pub. No.: US 2003/0087601 A1
(43) Pub. Date: May 8, 2003

(54) Method and system for functionally connecting a personal device to a host computer

(75) Inventors: Leedor Agam, Tel Aviv (IL); Yanki Margalit, Ramat-Gan (IL); Dany Margalit, Ramat-Gan (IL)

Correspondence Address: DR. MARK FRIEDMAN LTD., C/o Bill Polkinghorn, Discovery Dispatch, 9003 Florin Way, Upper Marlboro, MD, 20772, US

(73) Assignee: ALADDIN KNOWLEDGE SYSTEMS LTD.

(21) Appl. No.: 10/287,690

(22) Filed: Nov. 5, 2002

Related U.S. Application Data
(60) Provisional application No. 60/338,238, filed on Nov. 5, 2001.

(51) Int. Cl. H04B 7/24; H04B 5/00; H04Q 7/20; H04M 11/00

(52) U.S. Cl. 455/39; 455/41; 455/421

(57) ABSTRACT

In one aspect, the present invention is directed to an apparatus, system and method for communicating between a personal device and a host computer. The apparatus comprises means for wireless communication, for enabling communication with a personal device (which also comprises means for wireless communication) and means for wired communication for enabling communication with the host computer (which also comprises means for wired communication). A controller installed within the apparatus, controls the data transfer between the wireless and wired communication interfaces of the apparatus. The controller may perform additional computing operations, such as security related operations (e.g. digitally signing a document, ciphering, and so forth). The apparatus may further comprise a smartcard chip, for securely storing information, and also for performing the additional computing operations.

Implementations of the invention can be carried out in order to functionally connect a personal device, such as PDA, mobile phone, and so forth, to a host computer, or with an application executed on the host computer. The apparatus may be used to for security implementations, e.g. provision of PINs, keys, passwords, digitally signing of documents, and so forth. The personal device may also be used as input means for the apparatus, thereby enabling a large number of implementations, including applications with relevancy to cellular telephony.

### FIELD OF THE INVENTION

The present invention relates to the field of personal devices (e.g. mobile telephones and PDA), connectivity and applicability. More particularly, the invention relates to functionally connecting a personal device to a host computer.

### BACKGROUND OF THE INVENTION

The term Personal Device (PD) refers herein to any mobile handheld device that provides personal-nature functionality, e.g., cell phones and PDA (Personal Digital Assistant).

PD is characterized by two major features—portability and personal nature. However, due to its small size, which is derived from these features, it has also some drawbacks, like the limited input capability, small display, etc. Therefore, the necessity of functionally connecting a PD to a personal computer already has been indicated in the art.

PDA can be connected to a host computer via wired communication means, such as serial communication (e.g. RS232 and USB), parallel data communication, and so forth. However, wired communication is less convenient than wireless communication, since in wireless communication no cable is required. But cell phones do not support wired communication.

The present generation of PD devices can be connected to a computer via wireless communication means according the BT (Bluetooth) or IR wireless communication protocols. The major use of such connectivity is replicating data stored within the PD with data stored within a host computer and for backing up the data. However, since the BT/IR connectivity is quite new, the majority of the personal computers do not support BT/IR connectivity. In order to add such connectivity to a computer that does not support BT/IR, it is possible to add a computer-card which supports the BT/IR protocol.

Typically, a computer-card is a printed circuit on which electronic components are mounted. In order to operate the card, it should be “installed”, thus to be inserted into one of the computer's slots, and sometimes a corresponding software (driver) should be also installed into the computer. But beyond the inconvenience caused to the user according of this solution, there may be also problems with integrating the computer-card with the computer, e.g., hardware conjunctions, which sometimes require the involvement of a computer professional.

Another problem regarding this subject is connecting a PD to existing applications that are already installed on the computer. New applications can be designed to support BT/IR interface, however, it is mostly desired to provide such a capability to existing applications, thereby sparing the inconvenience of developing and installing new versions of the application. Moreover, sometimes the manufacturer of the applications does not exists anymore and therefore new versions of the application that support the BT/IR interface, probably will not be developed.

An example to such an application is the PIN entry interface. A great deal of applications, especially applications with affinity to security such as VPN logging-in and banking, ask the user to type a PIN (Personal Identification Number) and/or password as means for authenticating the user (referred in the art as “PIN Entry”). The PIN Entry process has a major drawback—remembering and typing the PIN is not convenient from the user's point of view. But beyond the inconvenience there is a severe problem—the ease of “hacking” the PIN. The data conveyed from a PIN Entry interface to an application is usually encrypted, and therefore this channel is quite secure. However, the stage of typing the PIN is very vulnerable since the key-strokes can be intercepted by a “hacking” utility.

The subject of PIN Entry has affinity to data security. The term data security refers in the prior art to three major subjects—preventing the access to data from unauthorized objects, authentication and digital signature. Typically, such functionality can be carried out by encryption/decryption methods. Typically encryption/decryption methods involve the use of “keys”. Methods in which the key used for decryption is identical to the key used for encryption are called “symmetric methods”, and methods wherein the key used for decryption differs from the key used for encryption are called “asymmetric methods”. It should be noted that the term security refers herein to data security.

“Security token” is a device operative for security purposes, e.g. the eToken, manufactured by Aladdin Knowledge Systems. From the hardware point of view, the security token is a microcomputer connected to a host computer via wired communication. From the functionality point of view, the device is applicable for security purposes, such as a gateway from which a PIN is provided to the host computer.

A typical application of the security token is PIN Entry. According to this application the user types a password on the host computer's keyboard. From the host computer the password is conveyed to the token via the wired communication channel, and upon receiving the right password on the security token, the PIN is returned to the host computer. The most vulnerable point of this application is the key strokes of the password, which the user type's on the host's keyboard.

According to another application of the security token, the PIN is returned to the host computer without any involvement of the user, i.e. without the stage of typing the password. From user's point of view, the PIN Entry process is facilitated since the user doesn't have to type the password. From the security point of view, the major vulnerable point is eliminated. However, the drawback is that the user has to take care not to leave the token at the host computer, and since the token has no other purpose, it is a burden to the user.

It is therefore an object of the present invention to provide a method and system for enabling communication between a PD coupled with WPC (Wireless Proximity Communication) interface with a computer, via wireless proximity communication.

It is another object of the present invention to provide a method and system for connecting a PD with existing applications being executed on a computer, without upgrading the application.

It is yet another object of the present invention to provide a method and system for using a PD in a PIN Entry process.

It is a further object of the present invention to provide a method and system for carrying out “Secure PIN Entry” of a PD or security token.

Other objects and advantages of the invention will become apparent as the description proceeds.

### SUMMARY OF THE INVENTION

In one aspect, the present invention is directed to an apparatus for enabling communication between a personal device coupled with a wireless proximity communication interface (e.g., proximity radio signals and infrared signals) and a host computer coupled with a wired communication interface (e.g., USB, RS232, parallel communication), comprising: a wired communication interface, corresponding to the wired communication interface of the host computer, for enabling communication between the apparatus and the host computer; a wireless proximity communication interface, corresponding to the wireless proximity communication interface of the personal device, for enabling communication between the apparatus and the personal device; and a controller, for enabling communication between the wired interface of the apparatus and the wireless proximity communication interface of the apparatus. The apparatus may further comprise a processing means (e.g. a smartcard chip), for performing operations (e.g., encryption, decryption, cipher, ECC, RSA, PKI, DES, MD5 and RC4) such as computing operations (e.g. converting between data that corresponds to the wireless proximity communication interface and data that corresponds to the wired communication interface), secure computing operations, storing data, securely storing data, and so forth.

In another aspect, the present invention is directed to a system for enabling communication between a personal device coupled with a wireless proximity communication interface and a host computer, the host computer being coupled with a wired communication interface, comprising: a token apparatus for enabling communication between the personal device and the host computer; and an agent (e.g. an EXE file, a script, a plug-in and an injected code within a third application), being executed by the host computer, for interacting with the wired communication interface and with at least one component (e.g. software/hardware element) of the host computer; thereby enabling communicating of the personal device with the host computer.

The system may further comprise a processing device (e.g. a smartcard chip), being a part of the apparatus, for enabling the operations such as computing operations, secure computing operations, storing data, securely storing data, security related operations (e.g. ECC, RSA, PKI, DES, and digitally signing a document), and so forth.

According to a preferred embodiment of the invention, the agent is used for operations such as providing a PIN received from the personal device to the application, executing a third application, communicating with an application being executed by the host computer, retrieving and altering data stored within the host computer or accessible by the host computer, processing data received from the personal device, executing at least one request contained within the data, digitally signing a document, and so forth.

The execution of a request may be implemented using an application being executed by the host computer, e.g. a security-related application. According to one embodiment of the invention, the agent executes code for accessing an application using a PIN received from the personal device. By implementing the invention in conjunction with a logon-related application, a secure logon using the personal device is achieved.

In another aspect, the present invention is directed to a method for functionally connecting a personal device to an application executed by a host computer system, comprising: providing an apparatus for communicating between the personal device and the host computer, such that the apparatus comprising a wired communication interface, corresponding to the wired communication interface of the host computer, for enabling communication between the apparatus and the host computer; a wireless proximity communication interface, corresponding to the wireless proximity communication interface of the personal device, for enabling communication between the apparatus and the personal device; and a controller, for enabling communication between the wired interface of the apparatus and the wireless proximity interface of the apparatus; holding a communication session between the apparatus and the host computer via the wireless communication means of the personal device and the wireless communication means of the apparatus, thereby conveying data between the personal device and the apparatus; and holding a communication session between the apparatus and the host computer via the wired communication means of the apparatus and wired communication means of the host computer, thereby conveying data between the apparatus and the host computer;

The method further comprises converting data received through the wireless communication session to a format suitable to the wired communication session. The data may be a PIN, which may be pre-stored within the personal device and/or generated (e.g. a One-Time-Password) by the personal device.

The invention further comprising processing the data by processing means within the security token before the data reaches to the computer system. The processing may be for performing operations such as security-related operations, PIN entry, secure PIN entry, logon to an application, secure logon to an application, digital signature, authentication, and so forth.

### BRIEF DESCRIPTION OF THE DRAWINGS

The present invention may be better understood in conjunction with the following figures:

FIG. 1 schematically illustrates a WPC Token, according to a preferred embodiment of the invention.

FIG. 2 schematically illustrates the components for communicating between a token and a host computer, according to a preferred embodiment of the invention.

FIG. 3 schematically illustrates the components of a WPC Token, according to another preferred embodiment of the invention.

FIG. 4 is an electronic diagram of a WPC Token coupled with IR interface, according to a preferred embodiment of the invention.

FIG. 5 is an electronic scheme of a WPC Token for providing infrared interface to a host, according to another preferred embodiment of the invention.

FIG. 6 schematically illustrates a PIN Entry scheme of a dial-up application, according to the prior art.

FIG. 7 schematically illustrates a PIN Entry scheme of a dial-up application, according to a preferred embodiment of the invention.

FIG. 8 schematically illustrates the course of a PIN (or any data) from a PD to an application executed by a host computer, according to a preferred embodiment of the invention.

FIG. 9 schematically illustrates a Secure PIN Entry scheme, according to a preferred embodiment of the invention.

FIG. 10 schematically illustrates a Secure PIN Entry scheme which uses biometric analysis, according to a preferred embodiment of the invention.

### DETAILED DESCRIPTION OF THE PREFERRED EMBODIMENT

In order to facilitate the reading of the description herein, the following terms and acronyms are explained:

The term Wireless Proximity Communication (WPC) refers to intercommunication between two or more devices from a short distance. For example, Bluetooth, IrDA, ISO 14443, RFID are WPC protocols.

IR—Infrared.

IrDA (Infrared Data Association)—a well-known protocol for infrared communication. Further details can be found in Bluetooth homepage, www.irda.com.

BT—Bluetooth™—A wireless proximity radio signal protocol. Further details can be found in Bluetooth homepage, www.bluetooth.com.

RFID (Radio Frequency Identification)—A technology that incorporates the use of radio signal to uniquely identify an object, animal, or person.

The term WPC Token refers herein to an apparatus for communicating between a PD supporting WPC and a host computer.

It should be noted that the term communication refers herein to data communication.

It should be further noted that the term PIN refers herein to any authentication means, including password, username, biometrics, and so forth.

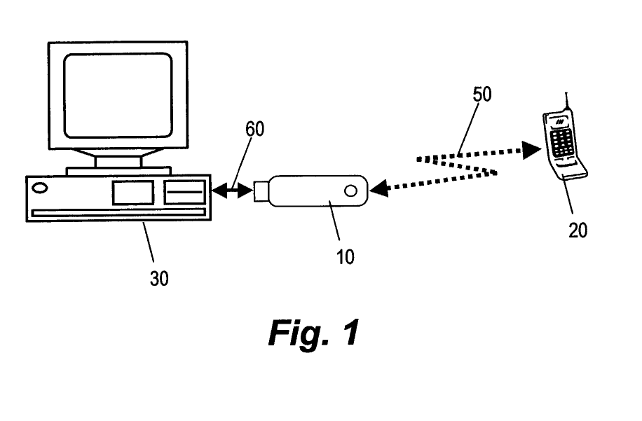

FIG. 1 schematically illustrates a communication scheme, wherein a WPC Token 10 intermediates between a PD 20 and a host computer 30, according to a preferred embodiment of the invention. By supporting a corresponding WPC protocol, token 10 can communicate with the PD 20. By supporting a wired communication protocol, e.g. USB, the token 10 can communicate with the host computer 30. Thus, the token 10 communicates with both the PD 20 and the host computer 30, and thereby enables communication between the PD 20 and the host computer 30.

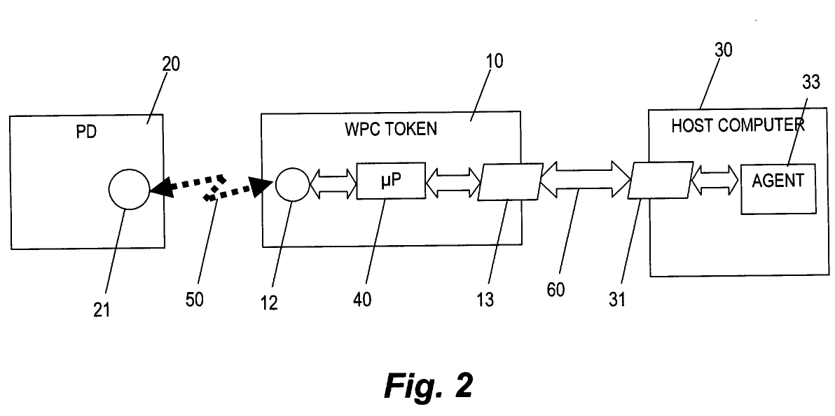

FIG. 2 schematically illustrates the components for communicating between a token and a host computer, according to a preferred embodiment of the invention. The PD 20 comprises a WPC interface 21, and the host computer 30 comprises a wired communication interface 31, e.g. a USB interface, a serial communication interface, etc.

In order to hold a WPC communication channel 50 with the interface 21 of the PD 20, the Token 10 comprises a corresponding WPC interface 12. In order to hold a wired communication channel 60 with the interface 31 of the host computer 30, the Token 10 comprises a corresponding wired communication interface 13.

The microcontroller 40 performs the data communication between the WPC interface 12 and the wired interface 13.

The host computer runs an agent 33, which communicates with the wired communication interface 31, thereby “functionally connected” to the PD 20. The agent 33, as an executable code executed by the host computer, can perform operations such as communicating with other applications executed by the host computer, retrieving and altering data, accessing hardware elements, communicating with other applications through a network, and so forth.

Those skilled in the art will appreciate that the agent 33 may operate as the server in a client/server scheme, wherein the client is the PD 20. For example, a user keeps an address book at his computer, and from time to time replicates it with the address book stored within the PD 20 (e.g. a cell phone). The replication process can be carried out as follows:

the user selects the replication option from his PD's menu;

the PD 20 transmits a predefined code to the token 10;

the code (or a corresponding code) is transferred from the token 10 to the computer 30, where it reaches to the agent 33;

upon receiving the code (i.e. the request), the agent 33 performs the replication, or alternatively invokes another program which performs the application.

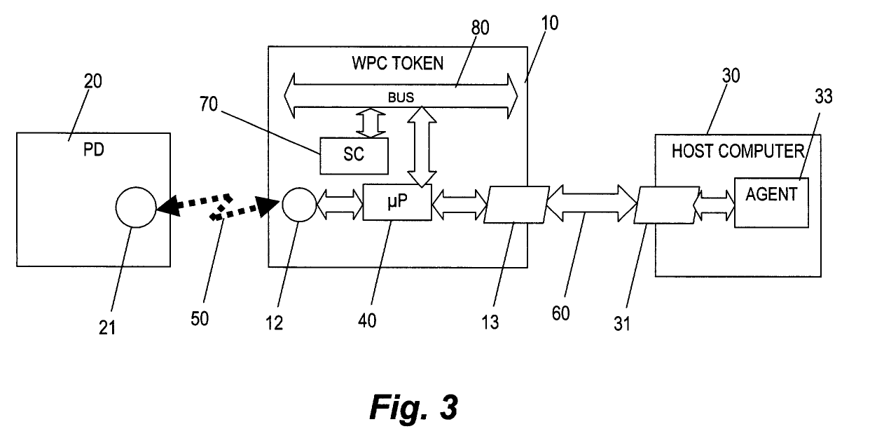

FIG. 3 schematically illustrates the components of a WPC Token, according to another preferred embodiment of the invention. In addition to the WPC Token described in FIG. 2, the WPC Token described in FIG. 3 comprises a smartcard chip 70. The smartcard 70 communicates with other components of the WPC Token 10 via the bus 80. The bus 80 is not shown in FIG. 2. The smartcard 70 provides better computing capability to the WPC Token 10, since it is distributed with appropriate software developing tools.

It should be noted that computational operations performed by the smartcard 70 can be performed also by the microcontroller 40, however microcontrollers are designed for specific operations, while smartcards are designed for a more generic computing purposes. Typically, smartcards comprise API (Application Program Interface), which facilitates the development process. But beyond the programming capability, smartcards also have a major feature that is not common in other type of processors the difficulty of reading their content. Smart cards are designed such that there is a barrier of reading their content. This feature has a major importance in security related applications. For example, storing a PIN within the memory unit of a smartcard is much safer than storing a key within other type of memory.

The WPC token actually enable two devices, e.g. a host computer and a PD, each of which supporting a different communication protocol, to intercommunicate. However, if the format of the data in one protocol differs from format of the data in the other protocol, then the data should be converted in order to correspond to the receiver's format. The conversion can be performed by the microprocessor or smartcard of the token, by a software application of the host computer, and so forth.

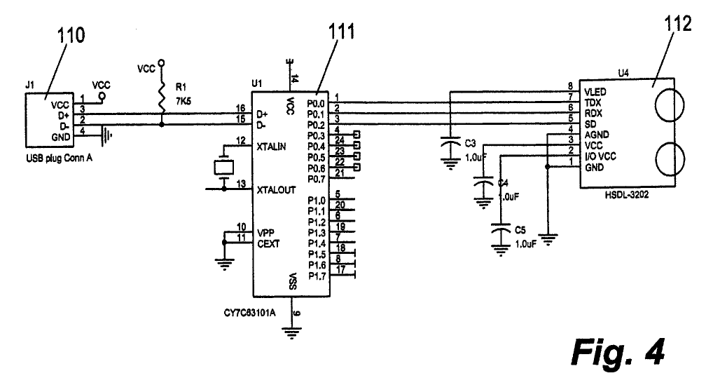

FIG. 4 is an electronic diagram of a WPC Token coupled with IR interface, according to a preferred embodiment of the invention. The WPC Token is connected to the host via a USB interface. Thus, the WPC Token comprises a microcontroller 111, which executes a program that performs the interface functionality, and a USB plug connector 110, through which the WPC Token is connected to the host. The microcontroller 111 comprises a processing unit and memory. It also comprises two ports, through which it controls other devices.

The microcontroller 111 is connected via one of its ports to an infrared chip 112. The infrared chip comprises an infrared LED, for transmitting information, and infrared receiver (e.g., photodiode or photoreceptor), for receiving IR signals from an external device, such as mobile phone. The transmitter and receiver are schematically illustrated as ovals.

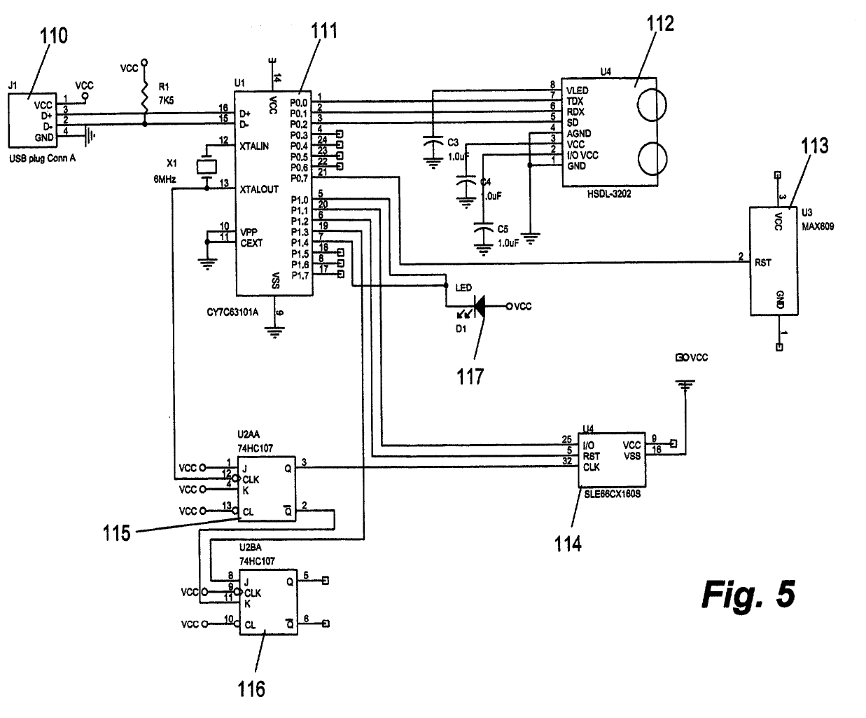

FIG. 5 is an electronic scheme of a WPC Token for providing infrared interface to a host, according to another preferred embodiment of the invention. Actually, this is the same circuit described in FIG. 4, which additionally is coupled with a smartcard chip 114, for performing a function that is a part of a security scheme. Currently, smartcard chips are provided with powerful developing tools, which make the smartcard chip as a proper choice for providing processing ability.

The frequency converter 115, 116, is used for converting the microcontroller clock frequency from 6 MHz to 3 MHz, in order to suit the smartcard chip 114. As known to the skilled person, an additional clock for the smartcard chip 114, instead of the frequency converter 115, 116.

Another component that does not appear in FIG. 4 is the reset component 113. Its function is to reset the microcontroller 111 whenever the voltage does not correspond to certain specifications, thus making sure that the microcontroller is provided the right voltage for its operation.

Another device that also does not appear in FIG. 4 is the LED 117, which is used for indicating a proper operation of the components of the WPC Token. The LED 117 is connected to microcontroller 111, thereby enabling the microcontroller to control the ON/OFF states of the LED. The LED can be used also as a troubleshooting means, by blinking in a certain way whenever some error is indicated.

Those skilled in the art will appreciate that the schemes illustrated by FIG. 4 and FIG. 5 comprise standard symbols, such as VCC as the power source, and the ground symbol. Thus, a person of ordinary skill in the art is able to embody such a WPC Token according to these schemes.

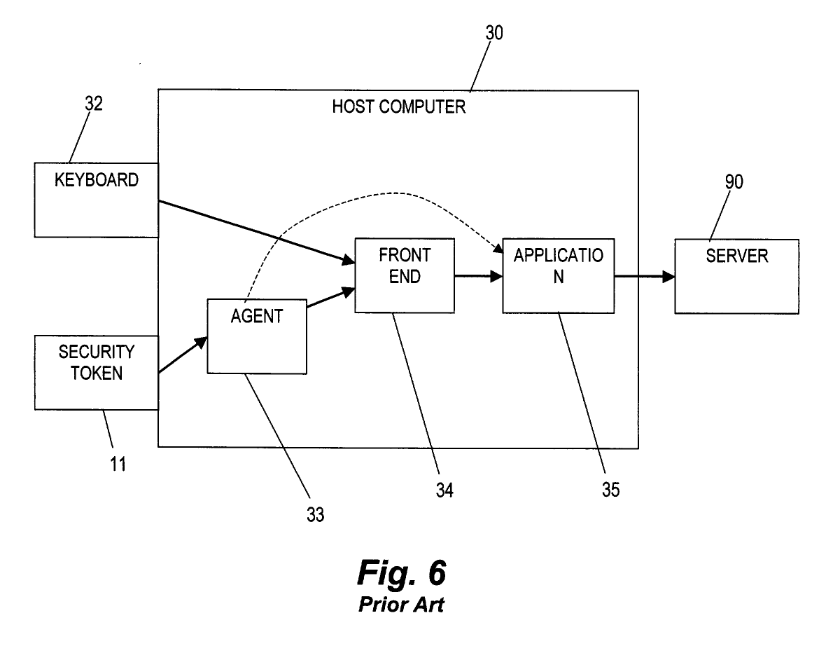

FIG. 6 schematically illustrates a PIN Entry scheme of a dial-up application, according to the prior art. The application 35, which is executed on the host computer 30, performs operations that require connection to the remote server 90. For example, the application 35 may be a dial-up program, upon which the computer can communicate with the remote server 90, which provides online banking services.

In order enable the application 35 to get the services from the remote server 90, the user has to identify himself to the server. Typically this is carried out by entering the PIN via the front-end 34 of the application 35. Entering the PIN can be carried out by two ways—typing the PIN on the keyboard 32, or by inserting a security token 11, which comprises the PIN, to the appropriate connector of the computer. If the application does not supports the provision of the PIN by the security token, an agent 33, which may be added to the computer, communicates with the security token 11 and fills the PIN in the appropriate field of the front-end 34, instead of the user's key strokes. Those skilled in the art will appreciate that there are a variety of methods for filling content within the input field of the front-end of an application by second application which is not a part of the application of interest. For example, in Windows-like GUI (Graphical User Interface) the API enables accessing the elements of the GUI. Web browsers are another type of applications in which its API can be used for accessing its GUI elements by a second application.

As known to a person of ordinary skill in the art, the agent 33 may be an EXE file, a script, a plug-in, injected code to a third application, and so forth.

It should be noted that although the communication channel between the computer and the remote server may be secured (e.g., the conveyed data is encrypted), there is still a vulnerable point, since the key strokes may be intercepted by a “hacking” utility, and later on to be sent to a malicious factor via the Internet.

Two benefits are achieved by using a security token—the user doesn't have to type the PIN, and therefore the PIN Entry process is facilitated. Also the provision of the PIN is less vulnerable to “hacking” since the token fills the PIN in the input field, instead of typing the PIN by the user. Since no key strokes are required, the major vulnerable point is bypassed.

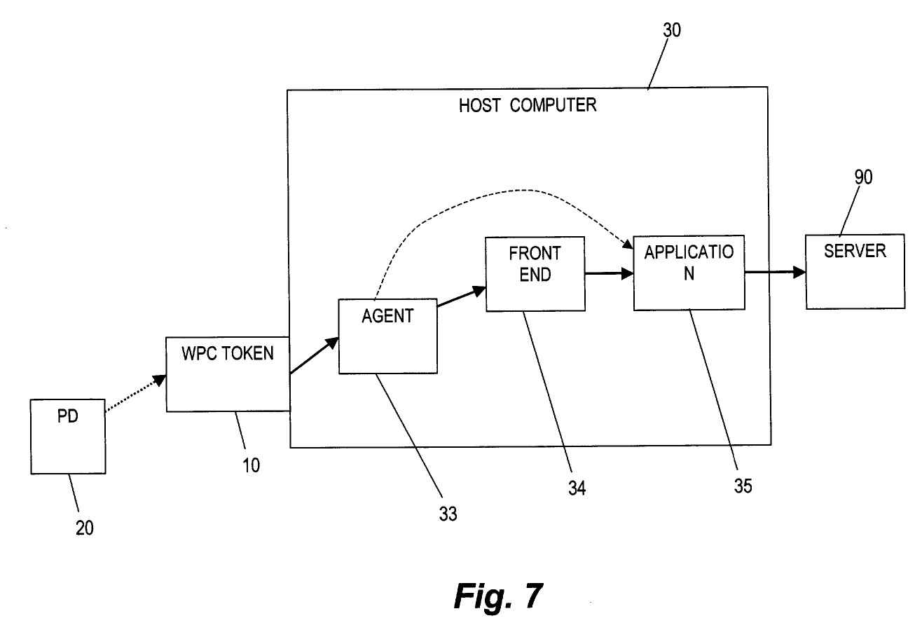

FIG. 7 schematically illustrates a PIN Entry scheme of a dial-up application, according to a preferred embodiment of the invention. Instead of a security token 11 as in FIG. 6, the token is replaced by a WPC Token 10, which actually performs the same function(s) as the security token 11, but additionally supports WPC communication with the PD 20.

Some benefits are achieved using a WPC Token in a PIN Entry process instead of a security token:

Due to its nature, the PD is usually carried by the user whenever he goes. Thus, by storing a PIN within the PD instead of within the token, the burden of carrying the token is solved.

By leaving the token in the computer the security wall is not broken, since the PIN is not stored within the security token, which can be forgotten within the computer, but rather within the PD, which is usually carried by the user whenever he goes.

Regarding FIG. 6 and FIG. 7, it should be noted that the agent 33 doesn't necessarily put the PIN within the input field of the front-end of the application, but can also to transfer it directly to the application (see the dashed curve).

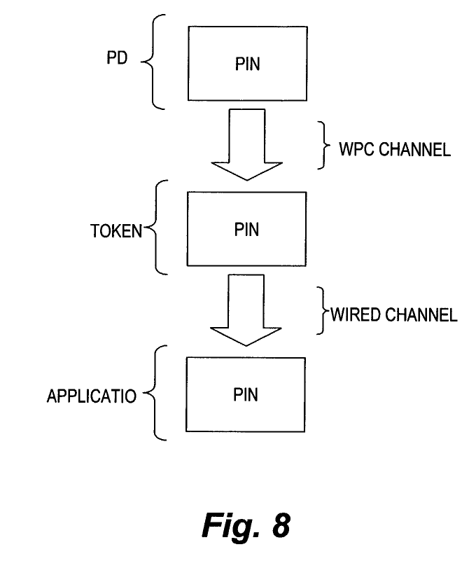

FIG. 8 schematically illustrates the course of a PIN (or any data) from a PD to an application executed by a host computer, according to a preferred embodiment of the invention.

At the PD, the user initiates the conveyance of the PIN to the WPC Token. This can be carried out by putting the PD in a mode which every input on its input means is transmitted by its WPC interface, and typing the PIN on the input means of the PD. A more sophisticated way is entering a predefined code on the PD's input means, transmitting the code to the token, and according to the code, conveying the appropriate data to the host computer. But beyond the use of the communication scheme described in FIG. 8 for PIN Entry, this communication scheme can be used for a great deal of applications. For example, a PD typically stores a database, such as a telephone book. However, due to its small size, the input means of a PD is less convenient than the input means of a personal computer. Using the WPC channel disclosed herein, it is possible to maintain a telephone list in both the PD and a host computer, and from time to time to replicate the database. The user may use the power of the personal computer to conveniently interact with the database for, e.g., editing the information, and then to replicate the data with the PD. The replication can be carried out using the WPC channel provided by the WPC Token.

According to this scheme, the data is transferred from the PD to the host computer as is, i.e. no data manipulation is performed between the PD to the application. However, since the WPC Token may comprise computing means, the data can be manipulated at the WPC Token.

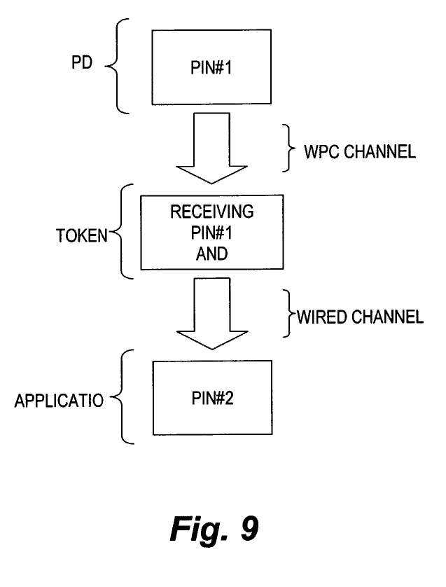

FIG. 9 schematically illustrates a Secure PIN Entry scheme, according to a preferred embodiment of the invention. The purpose of the scheme is to provide a PIN (referred in FIG. 9 as “PIN#2”) to the application executed on a host computer. The process comprises two stages:

Stage 1—Authenticating the user by the PD: At the PD, a first PIN (referred in FIG. 9 as “PIN#1”) is transmitted by the PD to the WPC Token via the WPC channel.

Stage 2—Authenticating the PD by the host: Upon receiving PIN#1 at the WPC Token, if the received PIN corresponds to the expected one, then PIN#2, which may be different than PIN#1 but do not, is conveyed to the application.

Those skilled in the art will appreciate that a great deal of security transfer of data may be implemented in the PIN Entry and Secure PIN Entry described above, e.g., encryption, decryption, ciphering, ECC, RSA, PKI, DES, MD5, RC4, etc.

For example, a digital signature of a document can be generated using the WPC Token as follows:

The user approaches the PD to the WPC Token, and then initiates the transmission of PIN#1 to the WPC Token. The initiation can be typing PIN #1 on the input means of the PD, clicking on a pre-dedicated button on the PD, and so forth.

Upon receiving PIN#1 at the WPC Token, if PIN #1 corresponds to the expected PIN the WPC Token generates PIN#2, and transmits it via the wired communication channel to an application executed on the host computer.

The application uses PIN#2 as the private key for encrypting the document.

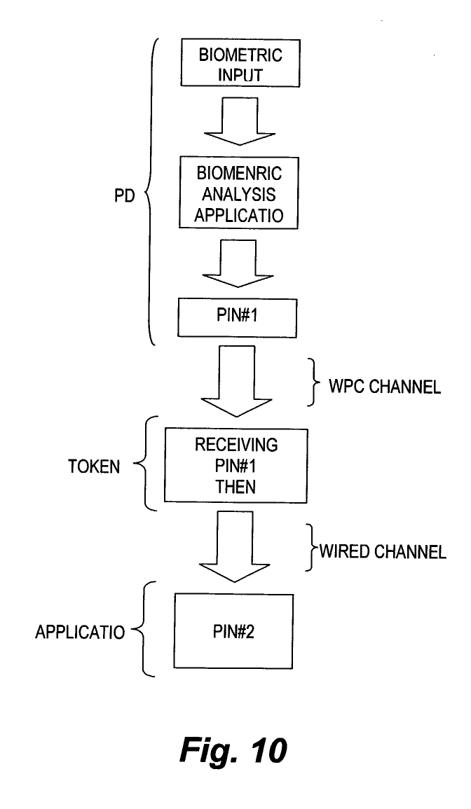

FIG. 10 schematically illustrates a Secure PIN Entry scheme which uses biometric analysis, according to a preferred embodiment of the invention. The PD comprises biometric input means, and a biometric analysis application. The biometric data, e.g. fingerprint, is sampled by the biometric input means (e.g. fingerprint reader), and then converted to PIN#1 by the biometric analysis application. Then, PIN#1 is sent to the WPC Token via a WPC channel. Upon receiving PIN#1 at the token, it is checked out for authenticating the user, and upon positive authentication a second PIN, marked in FIG. 10 as PIN#2, is generated by the computation facilities of the token or fetched from its data storage, and transmitted via the wired communication channel.

The invention can be embodied in other forms and ways, without losing the scope of the invention. The embodiments described herein should be considered as illustrative and not restrictive.

1. An apparatus for enabling communication between a personal device coupled with a wireless proximity communication interface and a host computer coupled with a wired communication interface, comprising:
a wired communication interface, corresponding to said wired communication interface of said host computer, for enabling communication between said apparatus and said host computer;
a wireless proximity communication interface, corresponding to the wireless proximity communication interface of said personal device, for enabling communication between said apparatus and said personal device; and
a controller, for enabling communication between said wired interface of said apparatus and said wireless proximity communication interface of said apparatus.

2. An apparatus according to claim 1, wherein said wireless proximity communication is selected from a group comprising proximity radio signals and infrared signals.

3. An apparatus according to claim 2, wherein said proximity radio signal corresponds to a protocol selected from a group comprising Bluetooth protocol, ISO 14443 and RFID.

4. An apparatus according to claim 2, wherein said infrared signals correspond to IrDA protocol.

5. An apparatus according to claim 1, wherein said wired communication interface is selected from a group comprising USB, serial data communication and parallel data communication interfaces.

6. An apparatus according to claim 1, further comprising a processing device, for performing operations selected from a group comprising computing operations, secure computing operations, storing data, and securely storing data.

7. A apparatus according to claim 6, wherein said processing device is a smartcard chip.

8. An apparatus according to claim 7, wherein said secure computing operations are selected from a group comprising encryption, decryption, cipher, ECC, RSA, PKI, DES, MD5 and RC4.

9. An apparatus according to claim 1, wherein said computing operations enable converting between data that corresponds to said wireless proximity communication interface and data that corresponds to said wired communication interface.

10. A system for enabling communication between a personal device coupled with a wireless proximity communication interface and a host computer, the host computer being coupled with a wired communication interface, comprising:
apparatus for enabling communication between the personal device and the host computer, said apparatus comprising a wired communication interface, corresponding to the wired communication interface of said host computer, for enabling communication between said apparatus and said host computer; a wireless proximity communication interface, corresponding to the wireless proximity communication interface of said personal device, for enabling communication between said apparatus and the personal device; and a controller, for enabling communication between said wired interface of said apparatus and said wireless proximity interface of said apparatus; and
an agent, being executed by said host computer, for interacting with said wired communication interface and with at least one component of said host computer;
thereby enabling communicating of said personal device with said host computer.

11. A system according to claim 10, wherein said component is selected from a group comprising hardware elements and software elements.

12. A system according to claim 10, further comprising a processing device, being a part of said apparatus, for enabling the operations selected from a group comprising computing operations, secure computing operations, storing data, securely storing data, and security related operations.

13. A system according to claim 12, wherein said processing device is a smartcard chip.

14. A system according to claim 12, wherein said security related operations are selected from a group comprising ECC, RSA, PKI, DES, and digitally signing a document.

15. A system according to claim 10, wherein said agent is selected from a group comprising an EXE file, a script, a plug-in and an injected code within a third application.

16. A system according to claim 10, wherein said controller enables performing of computing operations.

17. A system according to claim 10, wherein said agent is used for the operations selected from a group comprising: providing a PIN received from said personal device to said application, executing a third application, communicating with an application being executed by said host computer, retrieving and altering data stored within said host computer or accessible by said host computer, processing data received from said personal device, executing at least one request contained within said data, digitally signing a document.

18. A system according to claim 17, wherein executing said request is implemented using an application being executed by said host computer.

19. A system according to claim 17, wherein executing said request is implemented using a security-related application.

20. A system according to claim 10, wherein said agent executes code for accessing an application using a PIN received from said personal device.

21. A system according to claim 20, wherein said application is a logon-related application, thereby enabling secure logon using said personal device.

22. A method for functionally connecting a personal device to an application executed by a host computer system, comprising:
a) providing an apparatus for communicating between said personal device and said host computer, said apparatus comprising a wired communication interface, corresponding to the wired communication interface of the host computer, for enabling communication between said apparatus and the host computer; a wireless proximity communication interface, corresponding to the wireless proximity communication interface of the personal device, for enabling communication between said apparatus and the personal device; and a controller, for enabling communication between said wired interface of said apparatus and said wireless proximity interface of said apparatus;
b) holding a communication session between said apparatus and said host computer via the wireless communication means of said personal device and the wireless communication means of said apparatus, thereby conveying data between said personal device and said apparatus; and
c) holding a communication session between said apparatus and said host computer via the wired communication means of said apparatus and wired communication means of said host computer, thereby conveying data between said apparatus and said host computer;

23. A method according to claim 22, further comprising converting data received through the wireless communication session to a format suitable to said wired communication session.

24. A method according to claim 22, wherein said data is a PIN.

25. A method according to claim 22, wherein said data is pre-stored within said personal device and/or generated by said personal device.

26. A method according to claim 22, further comprising processing said data by processing means within said security token before said data reaches to said computer system.

27. A method according to claim 26, wherein said processing enables the operations selected from a group comprising security-related operations, PIN entry, secure PIN entry, logon to an application, secure logon to an application, digital signature, and authentication.
